(19) United States
(12) Patent Application Publication
(10) Pub. No.: US 2019/0200240 A1
(43) Pub. Date: Jun. 27, 2019

(54) METHOD OF FORMING VIRTUAL CELL IN HETEROGENEOUS NETWORK, MACRO BASE STATION AND TRANSMISSION POINT DEVICE

(71) Applicants: Xinghua SHI, Shanghai (CN); Haiyou GUO, Shanghai (CN)

(72) Inventors: Xinghua SHI, Shanghai (CN); Haiyou GUO, Shanghai (CN)

(73) Assignee: Alcatel Lucent, Nozay (FR)

(21) Appl. No.: 16/328,942

(22) PCT Filed: Aug. 30, 2017
(86) PCT No.: PCT/IB2017/001233

§ 371 Date: Feb. 27, 2019

(30) Foreign Application Priority Data
Aug. 30, 2016 (CN) 201610782073.X

(51) Int. Cl. H04W 16/18; H04W 52/24

(52) U.S. Cl. CPC H04W 16/18; H04W 88/02; H04W 52/244

(57) ABSTRACT

Embodiments of the present disclosure relate to a method of forming a virtual cell in a heterogeneous network, a macro base station and a transmission point device. At a macro base station, terminal devices and transmission points cooperating with the macro base station in a macro cell of the macro base station are divided into at least a first set of devices and a second set of devices based on positions of the terminal devices and positions of the transmission points, the first set of devices and the second set of devices being adjacent and non-over-lapping and each including at least one of the transmission points and at least one of the terminal devices. For a target terminal device in the first set of devices, channel state information between the target terminal device and the transmission points in the first set of devices and in the second set of devices is acquired. A power constraint for the transmission points is determined based on the channel state information, and based on the power constraint, at least one of the transmission points is selected for the target terminal device from the first set of devices to construct a virtual cell. Thereby, an interference coordination scheme is achieved which enhances the network performance while realizing low transmission signaling overhead and computational costs, and thus a construction of a virtual cell for the terminal device is facilitated.

### FIELD

Embodiments of the present disclosure generally relate to the field of wireless communications, and more specifically, to a method of forming a virtual cell for a terminal device in a heterogeneous network, a macro base station (MeNB) and a transmission point (TP) device.

### BACKGROUND

At present, wireless communication network is centered on a heterogeneous network, which refers to re-deploying several small power transmission nodes (also known as transmission point, TP) within coverage area of a traditional MeNB to form a heterogeneous system of different node types within the same coverage. As the traffic requirement continuously increases, the main challenge for the heterogeneous network is how to satisfy these increase demands, particularly in terms of traffic in a unit area and bit-rate required by an individual terminal device. To satisfy these demands, one possible solution is to deploy more TPs in the unit area. However, densification of the deployed TPs usually brings the problems of serious interference and frequent handover.

To solve the problems, a mechanism of forming a virtual cell for a terminal device is normally employed, wherein interference coordination and joint transmission are considered to select a group of TPs for a particular terminal device as the virtual cell for the particular terminal device. However, how to effectively select a TP for each terminal device to form a virtual cell and optimize TP's beamformer and data transmission power is still a challenge to be addressed.

### SUMMARY

In general, embodiments of the present disclosure provide a method for forming a virtual cell for a terminal device in a heterogeneous network, a macro base station and a transmission point device.

According to a first aspect of the present disclosure, there is provided a method of forming a virtual cell for a terminal device in a heterogeneous network. The method comprises: dividing, at a macro base station of the heterogeneous network, terminal devices and transmission points cooperating with the macro base station in a macro cell of the macro base station into at least a first set of devices and a second set of devices based on positions of the terminal devices and positions of the transmission points, the first set of devices and the second set of devices being adjacent and non-overlapping and each including at least one of the transmission points and at least one of the terminal devices; and for a target terminal device in the first set of devices, acquiring channel state information between the target terminal device and the transmission points in the first set of devices and in the second set of devices; determining a power constraint for the transmission points based on the channel state information; and selecting, based on the power constraint, at least one of the transmission points from the first set of devices for the target terminal device to construct a virtual cell for the target terminal device.

According to a second aspect of the present disclosure, there is provided a macro base station. The macro base station comprises: a controller; and a memory coupled to the controller and cooperating with the controller to cause the macro base station to execute the method according to the first aspect of the present disclosure.

According to a third aspect of the present disclosure, there is provided a method of forming a virtual cell for a terminal device in a heterogeneous network. The method comprises: receiving, at a transmission point of the heterogeneous network, identification information and sounding reference signal (SRS) configuration information related to terminal devices in at least a first set of devices and a second set of devices from a macro base station of the heterogeneous network, the transmission point being in the first set of devices or the second set of devices, the first set of devices and the second set of devices being divided by the macro base station based on positions of terminal devices and positions of transmission points cooperating with the macro base station, the first set of devices and the second set of devices being adjacent and non-overlapping and each including at least one of the transmission points and at least one of the terminal devices; receiving, based on the SRS configuration information, sounding reference signals from the terminal devices in the first set of devices and in the second set of devices; estimating, based on the sounding reference signals, channel state information between the transmission point and the terminal devices in the first set of devices and in the second set of devices; and transmitting the channel state information and the identification information of the corresponding terminal devices to the macro base station.

According to a fourth aspect of the present disclosure, there is provided a transmission point device. The transmission point device comprises: a controller; and a memory coupled to the controller and cooperating with the controller to cause the transmission point device to execute the method according to the third aspect of the present disclosure.

According to the solution of the embodiments of the present disclosure, an interference coordination mechanism can be achieved which enhances the network performance while realizing low transmission signaling overhead and computational costs, so as to optimize TP's beamformer and data transmission power, and thus a construction of a virtual cell for the terminal device is facilitated.

It will be appreciated that the contents described in the Summary does not aim to limit key or vital features of the embodiments of the present disclosure, or to limit scope of the present disclosure. Other features of the present disclosure are easy to understand through the following description.

### BRIEF DESCRIPTION OF THE DRAWINGS

Through the following detailed description with reference to the accompanying drawings, the above and other features, advantages and aspects of various embodiments of the present disclosure will become more apparent. In the drawings, same or similar reference signs represent the same or similar elements, wherein:

FIG. 1 shows a schematic diagram of a heterogeneous network in which embodiments of the present disclosure can be implemented;

FIG. 2 shows a schematic diagram of a procedure of constructing a virtual cell for a terminal device according to embodiments of the present disclosure;

FIGS. 3A and 3B show a flow chart of a method for constructing a virtual cell for a terminal device implemented at a MeNB according to embodiments of the present disclosure;

FIG. 4 shows a flow chart of a method for constructing a virtual cell for a terminal device implemented at a TP according to embodiments of the present disclosure;

FIG. 5 shows a structural block of an apparatus implemented at a MeNB according to embodiments of the present disclosure;

FIG. 6 a structural block of an apparatus implemented at a TP according to embodiments of the present disclosure; and

FIG. 7 shows a structural block of a device according to embodiments of the present disclosure.

### DETAILED DESCRIPTION OF EMBODIMENTS

The embodiments of the present disclosure will be described in more details with reference to the drawings. Although the drawings demonstrate some embodiments of the present disclosure, it should be appreciated that the present disclosure can be implemented in various manners and should not be limited to the embodiments explained herein. On the contrary, the embodiments are provided for a more thorough and complete understanding of the present disclosure. It should be understood that drawings and embodiments of the present disclosure are only exemplary and shall not limit the protection scope of the present disclosure.

As used herein, the term “macro base station” refers to traditional macro cell base stations. The term “transmission point” refers to small cell base stations, for example, low power transmission nodes such as micro base stations, pico base stations, femto base stations and the like.

The term “terminal device” or “user equipment” (UE) indicates any terminal devices capable of performing wireless communications with base stations or with each other. As an example, the terminal device can comprise a mobile terminal (MT), a subscriber station (SS), a portable subscriber station (PSS), a mobile station (MS) or an access terminal (AT) and the above devices mounted on vehicles. In the context of the present disclosure, the terms “terminal device” and “user equipment” can be used interchangeably for the sake of discussion.

The term “includes” and its variants are to be read as open-ended terms that mean “includes, but is not limited to.” The term “based on” is to be read as “based at least in part on.” The term “one embodiment” is to be read as “at least one embodiment.” The term “a further embodiment” is to be read as “at least a further embodiment.” Definitions related to other terms will be described in the following description.

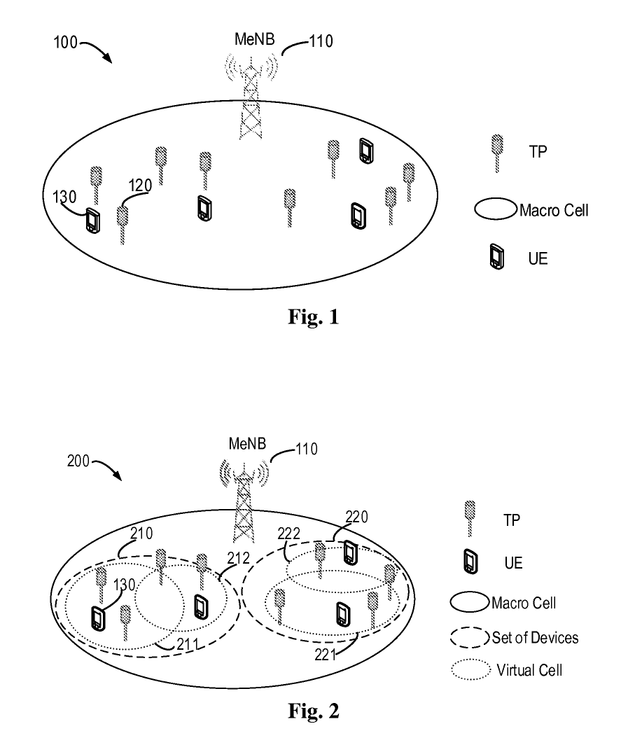

FIG. 1 illustrates a schematic diagram of a heterogeneous network 100 in which embodiments of the present application can be implemented. As shown in FIG. 1, the heterogeneous network 100 can comprise a MeNB 110, N TPs 120 co-operating with the MeNB 110, and M UEs 130 capable of communicating with the MeNB 110 and the TPs 120, wherein both M and N are any positive integers. As an example, FIG. 1 only demonstrates one MeNB, ten TPs and four UEs. It should be understood that the heterogeneous network 100 can comprise more MeNBs and operations in each macro cell of the heterogeneous network 100 are similar. Therefore, the following text only takes the MeNB 110 as an example for explanation. Besides, operations between TPs and operations between UEs within the macro cell of each MeNB are also similar. Therefore, the TPs 120 and the UEs 130 are used as instances here for illustration.

As shown in FIG. 1, the UEs 130 can connect to the MeNB 110 and the TPs 120 simultaneously in the macro cell of the MeNB 110 in the scenario of dual connectivity. The MeNB 110 can provide signaling coverage and control channels for all UEs within the macro cell of the MeNB 110, and the TPs 120 can provide data channels for particular UEs (e.g., the UEs 130).

The main concept of the embodiments of the present disclosure lies in that: UEs and TPs in the heterogeneous network are first roughly divided into a plurality of non-overlapping sets of devices, then interference from the neighboring set of devices is coordinated and a group of TPs is selected from TPs in the sets of devices to construct a virtual cell for UEs in the sets of devices. Details are described with reference to FIG. 2, which illustrates a schematic diagram of a procedure 200 of constructing a virtual cell for a UE.

As shown in FIG. 2, the UEs and TPs in the heterogeneous network 100 are first roughly divided into two sets of devices 210 and 220 (a first set of devices and a second set of devices) as indicated by the dotted line. It should be appreciated that more sets of devices (not shown) can be included in the macro cell of the MeNB 110 apart from the sets of devices 210 and 220. The two sets of devices 210 and 22 are adjacent and non-overlapping, and each of the two sets of devices 210 and 22 includes a plurality of UEs and a plurality of TPs (two UEs and four TPs demonstrated by FIG. 2 as an example). Then, for the UEs 130 in the set of devices 210 for instance, interferences of the TPs in the neighboring set of devices 220 are considered in order to perform interference coordination and a group of TPs is selected from TPs in the set of devices 210 to construct a virtual cell 211 for the UE 130. Based on the similar means, a virtual cell 212 can be constructed for another UE in the set of devices 210 and corresponding virtual cells 221 and 222 are established for respective UEs in the set of devices 220.

In the solutions according to the embodiments of the present disclosure, only the interferences from a neighboring set of devices are considered, instead of considering the interferences from all devices in the macro cell. Therefore, low transmission signaling overhead and computational costs can be achieved. Additionally, TP's beamformer and data transmission power are optimized by interference coordination, such that a construction of the virtual cell is more reliable, thereby enhancing network performance.

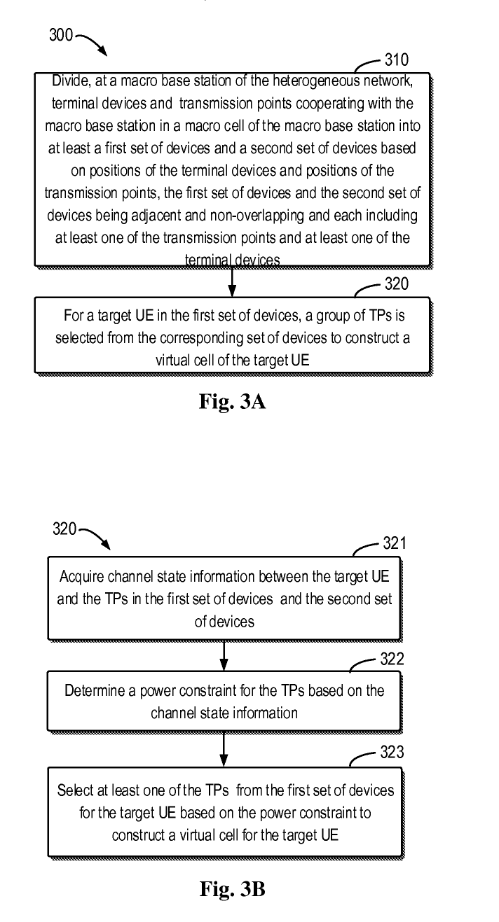

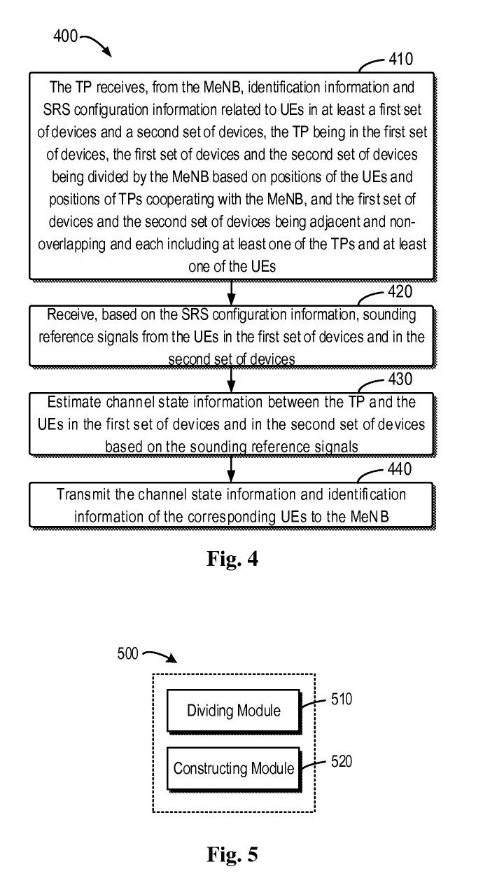

The interference coordination mechanism for constructing a virtual cell according to the embodiments of the present disclosure will be described in more details with reference to FIGS. 3A, 3B and 4. FIG. 3 illustrates a flow chart of a method 300 for constructing a virtual cell for a UE implemented at a MeNB. For instance, the method 300 can be implemented at the MeNB 110 shown in FIG. 1.

As shown in FIG. 3A, UEs and TPs within a macro cell of the MeNB are divided, based on positions of the UEs and positions of the TPs that cooperate with the MeNB, into at least a first set of devices and a second set of devices at 310. According to embodiments of the present disclosure, the first set of devices and the second set of devices are adjacent and non-overlapping and each includes at least one of the TPs and at least one of the UEs. The 310 can be used for a division of the sets of devices 210 and 220 shown in FIG. 2. In one embodiment, the size of a set of devices can be restricted to more efficiently lower transmission signaling overhead and computational costs. It should be noted that, according to embodiments of the present disclosure, any number of sets of devices can be divided in a cell, which is dependent on the amount and distribution of the devices and so on in the cell.

At 320, for a target UE in the first set of devices, a group of TPs is selected from TPs in the corresponding set of devices (e.g., for the UE 130 in the set of devices 210 shown in FIG. 2) to construct a virtual cell of the target UE (for example, shown by 211 of FIG. 2). FIG. 3B illustrates an example implementation of an action 320.

As shown in FIG. 3B, channel state information (CSI) between the target UE and TPs in the first and second sets of devices is acquired at 321 in this embodiment. For example, corresponding channel state information between the UE 130 shown in FIG. 2 and each of TPs in the sets of devices 210 and 220 is acquired. Assuming that the UE 130 has established a connection with the MeNB 110, the MeNB 110 can transmit to each of the TPs in the sets of devices 210 and 220 identification information and SRS configuration information related to each of the UEs in the sets of devices 210 and 220 in one embodiment. Each of the TPs in the sets of devices 210 and 220 can receive SRS from each of the UEs based on the SRS configuration information received from the MeNB 110, and estimate CSI between the TP per se and each of the UEs based on the SRS, and transmit the estimated CSI and the identification information of the corresponding UE together to the MeNB 110. Subsequently, the MeNB 110 can receive CSI between each UE and each TP in the sets of devices 210 and 220, and then acquire CSI between the target UE (e.g., the UE 130) and each of the TPs in the sets of devices 210 and 220.

According to one embodiment of the present disclosure, the MeNB 110 can receive only CSI related to a UE with a corresponding SRS signal power exceeding a predefined threshold. For example, the MeNB 110 can direct the TPs to only transmit CSI related to the UE with the corresponding SRS signal power exceeding the predefined threshold. Accordingly, transmission signaling overhead and computational costs can be further reduced.

At 322, a power constraint for TPs is determined based on CSI. According to embodiments of the present disclosure, signal power related to the TPs in the set of devices 210 and interference power related to the TPs in the set of devices 220 are determined for the target UE based on CSI between the target UE (e.g., the UE 130) and each of the TPs in the sets of devices 210 and 220 acquired in 321, and the power constraint for TPs is determined based on the signal power and the interference power. In an exemplary embodiment, the power constraint for TPs can be determined based on an equation (1):

$${SINR}_{i} = \frac{\sum {P}_{S}}{\sum {P}_{1} + {σ}^{2}} \geq γ \qquad ( 1 )$$

where SINRᵢ is signal to interference and noise ratio (SINR) of the target UE i, Pₛ refers to signal power of each of the TPs in the set of devices (first set of devices) to which the UE i belongs for the UE i , P_{I} denotes signal power of each of the TPs in the neighboring set of devices (second set of devices) for the UE i, i.e., interference power, σ² indicates white noise power of the system and γ is a predefined threshold preconfigured by the system. Based on the equation (1), it can deduct the following power constraint for TPs:

$$\sum {P}_{1} \leq \frac{1}{γ} \sum {P}_{S} - {σ}^{2} \qquad ( 2 )$$

The equation (2) is a power constraint for TPs in the neighboring set of devices. According to embodiments of the present disclosure, when a virtual cell is constructed for the UE 130 in the set of devices 210, signal power Pₛ of the TPs in the set of devices 210 is given. Based on the power constraint of the equation (2), power of the TPs in the set of devices 220 can be adjusted to satisfy the power constraint. Thus, interference from the neighboring set of devices can be controlled to realize interference coordination.

At 323, at least one TP is selected, based on the power constraint, from the first set of devices for the target UE to construct a virtual cell for the target UE. Interference coordination can be performed under the power constraint determined at 322, so as to optimize selection of one group of TPs from the first set of devices for the target UE to construct a virtual cell at 323. The specific implementation of constructing a virtual cell involves TP selections, beam forming design and power setting. The construction can be performed by any suitable technique known in the art or to be developed for constructing virtual cells. This will not be repeated here to avoid confusing the present invention.

According to embodiments of the present disclosure, only channel information between the UE and the TPs in the neighboring set of devices is estimated, and interference from the TPs in the neighboring set of devices is controlled for each UE just by setting a constraint condition for power of the TPs. Thus, transmission signaling overhead and computational complexity are greatly reduced.

The inventor validates this. Assuming that the TPs in the macro cell of the MeNB are divided into K sets of devices, each set comprises Mᵢ UEs and Nᵢ TPs, i=1, 2, . . . , K, wherein

$$M = {\sum }_{i = 1}^{K} {M}_{i} , N = {\sum }_{i = 1}^{K} {N}_{i} .$$

If channel information between all of the UEs and the TPs in the macro cell is estimated, the signaling cost is Cᵢ×M×N, wherein C₁ represents cost of each signaling for a pair of a TP and a UE. In contrast, only channel information between the UE and the TPs in the neighboring set of devices is estimated and the signaling cost is reduced to C₁Σᵢ₌₁^{K}Mᵢ×(Σ_{i∈{neighboring device set}}Nᵢ), according to the embodiments of the present disclosure.

The computational complexity of applying an optimized algorithm for all of the UEs and the TPs in the macro cell is C₂×M^{α}×N^{β}, wherein C₂, α and β(α, β≥1) are experience values selected dependent on optimized objects and algorithms. By contrast, the computational complexity of an optimized algorithm for determining the power constraint according to embodiments of the present disclosure is

$${C}_{3} {\sum }_{i = 1}^{K} {M}_{i}^{α} \times {N}_{i}^{β} ,$$

wherein C₃, α and β(α, β≥1) are experience values selected dependent on optimized objects and algorithm. The value of C₃ may be a value larger than C₂ because more constraints are considered. The total computational complexity will be reduced greatly even though C₃≥C₂.

FIG. 4 illustrates a flow chart of a method 400 for constructing a virtual cell for a UE at a TP according to embodiments of the present disclosure. The method 400 can be implemented at any of the TPs (e.g., the TP 120) shown in FIGS. 1 and 2 for instance.

As shown in FIG. 4, a TP receives from the MeNB of the heterogeneous network identification information and SRS configuration information related to UEs in at least a first set of device and a second set of devices at 410. The TP is in the first set of devices or the second set of devices (e.g., the set of devices 210 or 220 shown in FIG. 2). The first set of devices and the second set of devices are divided by the MeNB based on positions of the UEs and positions of the TPs cooperating with the MeNB, and the first set of devices and the second set of devices are adjacent and non-overlapping and each includes at least one of the TPs and at least one of the UEs.

At 420, SRS of the UEs in the first set of devices and in the second set of devices is received based on the SRS configuration information. For example, each UE in the macro cell of the MeNB 110 can transmit SRS to each TP in the macro cell. The TP in the sets of devices 210 and 220 receives SRS configuration information related to the UEs in the sets of devices 210 and 220 at 410, and then receives SRS of the UEs in the sets of devices 210 and 220 based on the SRS configuration information.

At 430, CSI between the TP and the UEs in the first set of devices and in the second set of devices is estimated based on SRS. Any channel estimate technologies known in the art or to be developed can be utilized here and will not be repeated.

At 440, CSI and identification information of the corresponding UE are transmitted to the MeNB. In one embodiment, the TP can transmit to the MeNB the CSI between the TP and each of the UEs in the first set of devices and in the second set of devices estimated at 430 and identification information of the corresponding UE. As an alternative, the TP can transmit to the MeNB the CSI between the TP and part of the UEs in the first set of devices and in the second set of devices estimated at 430 and identification information of the corresponding UE. According to one embodiment of the present disclosure, the TP can determine whether signal power of the SRS received from the given UE exceeds a predefined threshold, and transmits the CSI related to the given UE to the MeNB in response to determining that the signal power of the received SRS exceeds the predefined threshold. Thus, transmission signaling overhead and computational costs can be further decreased.

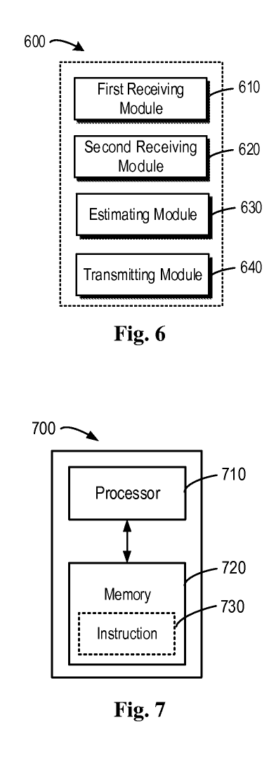

The methods of forming a virtual cell for a UE implemented at a MeNB and at a TP according to embodiments of the present disclosure are described above with reference to FIGS. 3A, 3B and 4. Correspondingly, embodiments of the present disclosure can also provide devices of forming a virtual cell for a UE at a MeNB and at a TP. The devices will be described in details with reference to FIGS. 5 and 6.

FIG. 5 illustrates a structural block of an apparatus 500 implemented at a MeNB according to embodiments of the present disclosure. It should be appreciated that the apparatus 500 can be implemented on the MeNB shown in FIGS. 1 and 2 for example. Alternatively, the apparatus 500 can be the MeNB per se.

As shown in FIG. 5, the apparatus 500 comprises a dividing module 510 and a constructing module 520. The dividing module 510 can be configured to divide, based on positions of UEs and positions of TPs cooperating with the MeNB, the UEs and the TPs in a macro cell of the MeNB into at least a first set of devices and a second set of devices (e.g., sets of devices 210 and 220 shown in FIG. 2). The first set of devices and the second set of devices are adjacent and non-overlapping, and each includes at least one of the TPs and at least one of the UEs. The constructing module 520 can be configured for a target UE in the first set of devices (e.g., the UE 130 in FIG. 2): to acquire CSI between the target UE and the TPs in the first set of devices and in the second set of devices; determine a power constraint for TPs based on the CSI; and select at least one TP for the target UE from the first set of devices based on the power constraint to construct a virtual cell for the target UE (e.g., 211 in FIG. 2).

According to embodiments of the present disclosure, the constructing module 520 can comprise (not shown): a transmitting module configured to transmit identification information and SRS configuration information related to the UEs in the first set of devices and in the second set of devices to the TPs in the first set of devices and in the second set of devices; a receiving module configured to receive CSI related to the UEs in the first set of devices and the second set of devices estimated by the TPs in the first set of devices and the second set of devices via a sounding reference signal received based on the SRS configuration information, and identification information of the corresponding UE; and a first determining module configured to determine CSI between a target UE and the TPs in the first set of devices and in the second set of devices based on the received CSI and identification information.

According to embodiments of the present disclosure, the constructing module 520 also comprises (not shown): a second determining module configured to determine signal power related to the TPs in the first set of devices and interference power related to the TPs in the second set of devices for the target UE based on the CSI between the target UE and the TPs in the first set of devices and in the second set of devices; and a third determining module configured to determine a power constraint for TPs based on the signal power and the interference power.

According to embodiments of the present disclosure, the receiving module is further configured to receive the CSI related to a terminal device having a corresponding SRS signal power exceeding a predefined threshold.

FIG. 6 illustrates a structural block of an apparatus 600 implemented at a TP according to embodiments of the present disclosure. It should be understood that the apparatus 600 can be performed on the TP 120 shown in FIG. 1 for instance. Alternatively, the apparatus 600 can be the TP per se. The TP can be in a first set of devices or a second set of devices of a macro cell of the MeNB. As mentioned above, the first set of devices and the second set of devices can be divided by the MeNB based on positions of UEs and positions of TPs cooperating with the MeNB. The first set of devices and the second set of devices are adjacent and non-overlapping and each includes at least one of the TPs and at least one of the UEs.

As shown in FIG. 6, the apparatus 600 can comprise a first receiving module 610, a second receiving module 620, an estimating module 630 and a transmitting module 640. The first receiving module 610 can be configured to receive from the MeNB of the heterogeneous network identification information and SRS configuration information related to the UEs in at least the first set of devices and the second set of devices. The second receiving module 620 can be configured to receive, based on the SRS configuration information, SRS of the UEs in the first set of devices and in the second set of devices. The estimating module 630 can be configured to estimate CSI between the TP and the UEs in the first set of devices and in the second set of devices based on the SRS. The transmitting module 640 can be configured to transmit the CSI and identification information of the corresponding UE to the MeNB.

According to one embodiment of the present disclosure, the transmitting module 640 can comprise (not shown): a determining sub-module configured to determine whether signal power of the SRS received from the given UE exceeds a predefined threshold; and a transmitting sub-module configured to transmit the CSI related to the given UE to the MeNB in response to determining that the signal power of the received SRS exceeds the predefined threshold.

It should be appreciated that each module disclosed in the apparatuses 500 and 600 respectively corresponds to each action in the methods 300 and 400 described with reference to FIGS. 3A, 3B and 4. Besides, the apparatuses 500 and 600 and the operations and features of the modules included therein correspond to operations and features described above with reference to FIGS. 3A, 3B and 4 and have the same effects. The specific details will not be repeated.

Modules included in the apparatuses 500 and 600 can be implemented by a variety of manners, including software, hardware, firmware or any combinations thereof. In one embodiment, one or more modules can be implemented using software and/or firmware, e.g., machine-executable instructions stored on the storage medium. Apart from the machine-executable instructions or as an alternative, part or all of the modules in the apparatuses 500 and 600 can be at least partly implemented by one or more hardware logic components. As an example rather a restriction, available exemplary types of hardware logic components comprise field programmable gate array (FPGA), application-specific integrated circuit (ASIC), application-specific standard product (ASSP), system-on-chip (SOP), complex programmable logic device (CPLD) and so on.

The modules shown in FIGS. 5 and 6 can be partially or fully implemented by hardware modules, software modules, firmware modules or any combinations thereof.

FIG. 7 illustrates a block diagram of a device 700 suitable for performing embodiments of the present disclosure. The device comprises a controller 710, which controls operations and functions of the device 700. For instance, in some embodiments, the controller 710 can execute various operations by means of instructions stored in the memory 720 coupled thereto. The memory 720 can be any appropriate type suitable for the local technical environment, and can be implemented by using any suitable data storage technologies, including but not limited to, semiconductor-based storage device, magnetic storage device and system, optical storage device and system. Although FIG. 7 only illustrates a memory unit, the device 700 can comprise a plurality of physically different memory units.

The controller 710 can be any appropriate type suitable for the local technical environment and can comprise but not limited to universal computer, dedicated computer, microcontroller, digital signal controller (DSP) and one or more in the controller-based multi-core controller architecture. The device 700 can also comprise a plurality of controllers 710.

The device can implement the MeNB 110 and/or the TP 120. When the device 700 acts as the MeNB 110, the controller 710 and the memory 720 can cooperate to realize the above method 300 described with reference to FIGS. 3A and 3B. When the device 700 serves as the TP 120, the controller 710 and the memory 720 can cooperate to realize the above method 400 described with reference to FIG. 4. All features described with reference to FIGS. 3A, 3B and 4 are applicable to the device 700 and will not be repeated here.

Generally speaking, various example embodiments of the present disclosure can be implemented in hardware or dedicated circuit, software, logic, or any combinations thereof. Some aspects can be implemented in hardware while other aspects can be implemented in firmware or software executed by controller, microprocessor or other computing devices. When each aspect of the embodiments of the present disclosure is illustrated or described as block diagram and flow chart or represented using some other graphics, it should be understood that block, apparatus, system, technology or method described here can serve as non-restrictive examples implemented in hardware, software, firmware, dedicated circuit or logic, universal hardware, or controller or other computing devices, or any combinations thereof.

As an example, embodiments of the present disclosure can be described in the context of the machine-executable instructions, which is included such as in program modules executed in means on the target real or virtual processor. In general, the program modules include routine, program, library, object, class, component, data structure and the like, which execute specific tasks or implement specific abstract data structures. In each embodiment, functions of the program modules can be combined or split in a local or distributed device. In the distributed device, the program modules can be located in the local storage medium and the remote storage medium.

The computer program codes for implementing the method of the present disclosure can be programmed using one or more programming languages. The computer program codes can be provided to a processor of a universal computer, a dedicated computer or other programmable data processing apparatuses, such that the program codes, when executed by the computer of other programmable data processing apparatuses, cause functions/operations stipulated in the flow chart and/or block diagram to be performed. The program codes can be implemented fully on the computer, partially on the computer, as an independent software package, partially on the computer and partially on the remote computer, or completely on the remote computer or server.

In the text of the present disclosure, the machine-readable medium can be any tangible medium including or storing programs for or related to instruction executing system, apparatus or device. The machine-readable medium can be machine-readable signal medium or machine-readable storage medium. The machine-readable medium can comprise but not limited to electronic, magnetic, optical, electromagnetic, infrared, or semiconductor system, apparatus or device, or any suitable combinations thereof. More detailed examples of the machine-readable medium comprise an electrical connection having one or more wires, a portable computer disk, hard disk, random access memory (RAM), read-only memory (ROM), erasable programmable read-only memory (EPROM or flash), optical storage device, magnetic storage device, or any suitable combinations thereof.

Moreover, although operations are described in a particular order in the drawings, it should not be appreciated that these operations are required to be performed according to this particular sequence or in succession, or a desired outcome can only be achieved by performing all shown operations. In some cases, multi-tasking or parallel processing can be beneficial. Likewise, although the above discussion includes some specific implementation details, they should be interpreted as descriptions of a particular embodiment of a particular invention rather than restrictions on scope of any invention or claims. Some features described in the context of separate embodiments in the description can also be combined to be implemented in one single embodiment. On the contrary, various features described in the context of a single embodiment can also be separately implemented in several embodiments or any suitable sub-combinations.

Although the subject matter has been described with languages specific to structure features and/or method actions, it should be understood that the subject matter defined in the attached claims does not limit to the above described particular features or actions. On the contrary, the above described particular features or actions are disclosed as exemplary forms for implementing the claims.

I/we claim:

1. A method of forming a virtual cell for a terminal device in a heterogeneous network, the method comprising:
dividing, at a macro base station of the heterogeneous network, terminal devices and transmission points cooperating with the macro base station in a macro cell of the macro base station into at least a first set of devices and a second set of devices based on positions of the terminal devices and positions of the transmission points, the first set of devices and the second set of devices being adjacent and non-overlapping and each including at least one of the transmission points and at least one of the terminal devices; and
for a target terminal device in the first set of devices,
acquiring channel state information between the target terminal device and the transmission points in the first set of devices and in the second set of devices;
determining a power constraint for the transmission points based on the channel state information; and
selecting, based on the power constraint, at least one of the transmission points from the first set of devices for the target terminal device to construct a virtual cell for the target terminal device.

2. The method of claim 1, wherein the acquiring channel state information comprises:
transmitting, to the transmission points in the first set of devices and in the second set of devices, identification information and sounding reference signal (SRS) configuration information related to the terminal devices in the first set of devices and in the second set of devices;
receiving channel state information related to the terminal devices in the first set of devices and in the second set of devices estimated by the transmission points in the first set of devices and in the second set of devices via sounding reference signals received based on the SRS configuration information, and the identification information of the corresponding terminal devices; and
determining, based on the received channel state information and the identification information, the channel state information between the target terminal device and the transmission points in the first set of devices and in the second set of devices.

3. The method of claim 2, wherein the determining a power constraint for the transmission points comprises:
determining, for the target terminal device, based on the channel state information between the target terminal device and the transmission points in the first set of devices and in the second set of devices, signal power related to the transmission points in the first set of devices and interference power related to the transmission points in the second set of devices; and
determining the power constraint of the transmission points based on the signal power and the interference power.

4. The method of claim 2, wherein the receiving the channel state information comprises:
receiving channel state information related to a terminal device having signal power of a corresponding sounding reference signal exceeding a predefined threshold.

5. A method of forming a virtual cell for a terminal device in a heterogeneous network, the method comprising:
receiving, at a transmission point of the heterogeneous network, identification information and sounding reference signal (SRS) configuration information related to terminal devices in at least a first set of devices and a second set of devices from a macro base station of the heterogeneous network, the transmission point being in the first set of devices or the second set of devices, the first set of devices and the second set of devices being divided by the macro base station based on positions of terminal devices and positions of transmission points cooperating with the macro base station, the first set of devices and the second set of devices being adjacent and non-overlapping and each including at least one of the transmission points and at least one of the terminal devices;
receiving, based on the SRS configuration information, sounding reference signals from the terminal devices in the first set of devices and in the second set of devices;
estimating, based on the sounding reference signals, channel state information between the transmission point and the terminal devices in the first set of devices and in the second set of devices; and
transmitting the channel state information and the identification information of the corresponding terminal devices to the macro base station.

6. The method of claim 5, wherein the transmitting the channel state information to the macro base station comprises:
determining whether signal power of a sounding reference signal received from a given terminal device exceeds a predefined threshold; and
transmitting, in response to determining that the signal power of the received sounding reference signal exceeds the predefined threshold, the channel state information related to the given terminal device to the macro base station.

7. A macro base station operating in a heterogeneous network, comprising:
a controller; and
a memory coupled to the controller and cooperating with the controller to cause the macro base station to execute actions including:
dividing, based on positions of terminal devices and positions of transmission points cooperating with the macro base station, the terminal devices and the transmission points in a macro cell of the macro base station into at least a first set of devices and a second set of devices, the first set of devices and the second set of devices being adjacent and non-overlapping and each including at least one of the transmission points and at least one of the terminal devices; and
for a target terminal device in the first set of devices,
acquiring channel state information between the target terminal device and the transmission points in the first set of devices and in the second set of devices;
determining a power constraint for the transmission points based on the channel state information; and
selecting, based on the power constraint, at least one of the transmission points from the first set of devices for the target terminal device to construct a virtual cell for the target terminal device.

8. The macro base station of claim 7, the acquiring channel state information comprises:
transmitting, to the transmission points in the first set of devices and in the second set of devices, identification information and sounding reference signal (SRS) configuration information related to the terminal devices in the first set of devices and in the second set of devices;
receiving channel state information related to the terminal devices in the first set of devices and in the second set of devices estimated by the transmission points in the first set of devices and in the second set of devices via sounding reference signals received based on the SRS configuration information, and the identification information of the corresponding terminal devices; and
determining, based on the received channel state information and the identification information, the channel state information between the target terminal device and the transmission points in the first set of devices and in the second set of devices.

9. The macro base station of claim 8, wherein the determining a power constraint for the transmission points comprises:
determining, for the target terminal device, based on the channel state information between the target terminal device and the transmission points in the first set of devices and in the second set of devices, signal power related to the transmission points in the first set of devices and interference power related to the transmission points in the second set of devices; and
determining the power constraint of the transmission points based on the signal power and the interference power.

10. The macro base station of claim 8, wherein the receiving the channel state information comprises:
receiving channel state information related to a terminal device having signal power of a corresponding sounding reference signal exceeding a predefined threshold.

11. A transmission point device operating in a heterogeneous network, comprising:
a controller; and
a memory coupled to the controller and cooperating with the controller to cause the transmission point device to execute actions including:
receiving, from a macro base station of the heterogeneous network, identification information and sounding reference signal (SRS) configuration information related to terminal devices in at least a first set of devices and a second set of devices, the transmission point device being in the first set of devices or the second set of devices, the first set of devices and the second set of devices being divided by the macro base station based on positions of terminal devices and positions of transmission point devices cooperating with the macro base station, the first set of devices and the second set of devices being adjacent and non-overlapping and each including at least one of the transmission point devices and at least one of the terminal devices;
receiving, based on the SRS configuration information, sounding reference signals from the terminal devices in the first set of devices and in the second set of devices;
estimating, based on the sounding reference signals, channel state information between the transmission point device and the terminal devices in the first set of devices and in the second set of devices; and
transmitting the channel state information and the identification information of the corresponding terminal devices to the macro base station.

12. The transmission point device of claim 11, wherein the transmitting the channel state information to the macro base station comprises:
determining whether signal power of a sounding reference signal received from a given terminal device exceeds a predefined threshold; and
transmitting, in response to determining that the signal power of the received sounding reference signal exceeds the predefined threshold, the channel state information related to the given terminal device to the macro base station.
